(19) United States
(12) Patent Application Publication
(10) Pub. No.: US 2019/0004676 A1
(43) Pub. Date: Jan. 3, 2019

(54) METHOD AND DEVICE FOR SWITCHING INPUT MODES

(71) Applicant: LENOVO (BEIJING) CO., LTD., Beijing (CN)

(72) Inventor: Yuanyuan DENG, Beijing (CN)

(21) Appl. No.: 16/023,669

(22) Filed: Jun. 29, 2018

(30) Foreign Application Priority Data
Jun. 30, 2017 (CN) 201710523537.X

(51) Int. Cl. G06F 3/0487; G06F 3/16; G10L 15/08

(52) U.S. Cl. CPC G06F 3/0487; G10L 2015/088; G10L 15/08; G06F 3/167

(57) ABSTRACT

An input mode method includes providing a first input mode of an application program which receives a first type of information from a user and detecting whether the first type of information comprises a pre-configured condition for switching the first input mode of the application program to a second input mode of the application program. The second input mode of the application program receives a second type of information from the user. The method further includes, if the first type of information comprises the pre-configured condition, switching the first input mode of the application program to the second input mode of the application program.

### CROSS-REFERENCES TO RELATED APPLICATION

This application claims priority to Chinese Patent Application No. 201710523537.X, filed on Jun. 30, 2017, the entire contents of which are hereby incorporated by reference.

### TECHNICAL FIELD

The present disclosure generally relates to the technical field of smart device interaction and, more particularly, to a method and a device for switching input modes.

### BACKGROUND

An input method is an essential tool of a terminal apparatus, and may have the highest usage frequency among all tools of the terminal apparatus. With the development of the terminal apparatus, more and more auxiliary devices are designed to be included in the terminal apparatus. For example, auxiliary devices related to the input method may include a microphone and a camera, etc., other than the traditional keyboard.

In an application program that supports hybrid input, the user often needs to switch between different input modes. For example, when using a chat application program, a personal assistant application program or a game application program, the user often needs to click a switch button to switch between the audio input mode, text input mode, and image input mode. As a result, the operation of the user can be interrupted, and the user may not have a fluent user experience.

### BRIEF SUMMARY OF THE DISCLOSURE

One aspect of the present disclosure provides an input mode method including providing a first input mode of an application program which receives a first type of information from a user and detecting whether the first type of information comprises a pre-configured condition for switching the first input mode of the application program to a second input mode of the application program. The second input mode of the application program receives a second type of information from the user. The method further includes, if the first type of information comprises the pre-configured condition, switching the first input mode of the application program to the second input mode of the application program.

Another aspect of the present disclosure provides a device including a processor; and an input device coupled to the processor. The input device is configured to receive a first type of information from a user via a first input mode. The processor is configured to detect whether the first type of information from the user and as received by the input device comprises a pre-configured condition for switching the first input mode of the input device to a second input mode of the input device. The second input mode of the input device is configured to receive a second type of information from the user. The processor is further configured to, responsive to the detected first type of information from the user comprising the pre-configured condition, switch the first input mode of input device to the second input mode in order to receive the second type of information from the user.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 illustrates a flow chart showing an example of an input mode switching method in accordance with some embodiments of the present disclosure;

FIG. 2 illustrates a schematic view showing a first application scenario of an input mode switching method in accordance with some embodiments of the present disclosure;

FIG. 3 illustrates a schematic view showing a second application scenario of an input mode switching method in accordance with some embodiments of the present disclosure;

FIG. 4 illustrates a schematic view showing a third application scenario of an input mode switching method in accordance with some embodiments of the present disclosure;

FIG. 5 illustrates a schematic view showing a fourth application scenario of an input mode switching method in accordance with some embodiments of the present disclosure;

FIG. 6 illustrates a schematic view showing an example of an application scenario of another input mode switching method in accordance with some embodiments of the present disclosure;

FIG. 7 illustrates a schematic view showing an example of an application scenario of another input mode switching method in accordance with some embodiments of the present disclosure;

FIG. 8 illustrates a schematic view showing an example of an application scenario of another input mode switching method in accordance with some embodiments of the present disclosure; and

FIG. 9 illustrates a schematic view of an example of a device for input mode switching in accordance with some embodiments of the present disclosure.

### DETAILED DESCRIPTION

Various solutions and features of the present disclosure will be described hereinafter with reference to the accompanying drawings. It should be understood that, various modifications may be made to the embodiments described below. Thus, the specification shall not be construed as limiting, but is to provide examples of the disclosed embodiments. Those skilled in the relevant art may derive modified embodiments without departing from the scope and spirit of the present disclosure.

Accompanying drawings included in the disclosure and forming a part of the disclosure merely illustrate some embodiments of the present disclosure, and are applied to explain principles of the present disclosure, together with the brief description section and the detailed description section of the present disclosure.

These and other features of the present disclosure will become apparent with reference to the accompanying drawings through detailed descriptions of non-limiting embodiments disclosed hereinafter. It should also be understood that, while the present disclosure are described with reference to certain embodiments, those skilled in the relevant art may still derive various other equivalent implementations of the present disclosure, and such equivalent implementations possess features described in the appended claims, all of which fall within the protection scope defined by the appended claims.

The foregoing and other aspects, features, and advantages of the present disclosure will become obvious with reference to the accompanying drawings and the following detailed descriptions. Specific embodiments of the present disclosure will be described with reference to the accompanying drawings; however, it should be understood that, the disclosed embodiments are merely examples of the present disclosure and may be implemented using various approaches. The well-known and/or repeated functions and structures are not described in details to prevent unnecessary or superfluous details from obscuring the present disclosure.

Thus, the specific structural and functional details of the present disclosure are not intended to be limiting, but are used as basis of the claims and representative basis for teaching those skilled in the relevant art any intrinsically appropriate specific structure to apply the present disclosure in various ways.

In the specification, terms such as “in one embodiment,” “in another embodiment,” “in an additional embodiment,” or “in other embodiments” may refer to one or more of the same or different embodiments of the present disclosure. Further, terms “including” and “comprising” and their derivatives mean inclusion without limitation. Further, the term “or” is inclusive, meaning “and/or”.

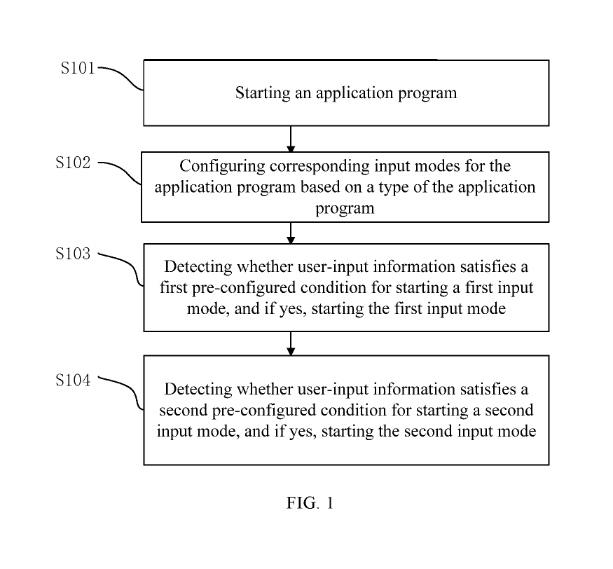

FIG. 1 illustrates a flow chart showing an example of an input mode switching method in accordance with some embodiments of the present disclosure. As shown in FIG. 1, the disclosed input mode switching method may include: starting an application program (S101), and configuring one or more corresponding input modes for the application program based on a type of the application program (S102). The method may further include: detecting whether user-input information satisfies a first pre-configured condition for starting a first input mode, and if the user-input information satisfies the first pre-configured condition for starting the first input mode, starting the first input mode (S103). The method may further include: detecting whether the user-input information satisfies a second pre-configured condition for starting a second input mode, and if the user-input information satisfies the second pre-configured condition for starting the second input mode, starting the second input mode (S104).

As such, technical solutions of the present disclosure may start the first input mode of the application program based on the user-input information, and when the latest user-input information satisfies the second pre-configured condition for starting the second input mode, the present disclosure may switch the current input mode from the first input mode to the second input mode, without further action from the user. Thus, the issue of the user feeling interrupted when manually switching the input modes may be prevented.

In one embodiment, at S102, configuring one or more input modes for the application program based on a type of the application program may include: determining whether the application program is a first-type application program; if the application program is the first-type application program, configuring an audio input mode and an image input mode for the first-type application program, and displaying input interfaces of the audio input mode and the image input mode on a display interface of a mobile terminal. The first-type application program may be a personal assistant application program or a game application program.

In some embodiments, in the audio input mode, an audio receiver, such as a microphone of the mobile terminal, may be utilized to collect audio data from the user that uses the mobile terminal, and a voice button representing the audio input mode may be displayed within the input interface of the audio input mode. The voice button may, for example, show a design of a microphone. Further, a change in the design (e.g., shape, color, weight of lines, etc.) of the voice button may be displayed, or a visual effect may be triggered, to indicate the beginning and/or end of the recording of the audio data.

Further, the recording of the audio data may be started or ended automatically or manually. For example, when the audio receiver detects a voice of the user that exceeds a pre-configured volume, a visual effect such as ripple or waves may show around the voice button to indicate the beginning of the recording of the audio data. Further, when the audio receiver no longer detects the voice of the user within certain amount of time, the visual effect disappears, indicating the end of the recording of the audio data.

In another example, the user may manually start to record audio data by clicking on the voice button. In response to the user's clicking, the voice button may change from the design of a single circle into a design of two concentric circles to reflect the beginning of the audio data recording. The user may once again click on the voice button to end the recording of the audio data, or the recording of the audio data may end automatically if no voice of the user is detected within certain amount of time.

Further, the recorded audio data may be converted into text for display on the display interface of the mobile terminal. Or, the recorded audio data is not converted into text but displayed as an audio message on the display interface of the mobile terminal, and the user may click the audio message to hear the recorded audio data. The present disclosure is not intended to be limiting.

In some embodiments, in the image input mode, an image-capturing device, such as a camera of the mobile terminal, may be utilized to capture an image desired by the user for input, and an image button representing the image input mode may be displayed within the input interface of the image input mode. The image button may, for example, show a design of a circle, two concentric circles, or a circle containing a plus sign, and the present disclosure is not limited thereto. The user of the mobile terminal may click the image button representing the image input mode to capture an image. For example, after the user clicks the image button representing the image input mode, a camera view may be displayed for the user to capture the image. In one embodiment, once an image is captured, the user may have the choice to decide whether or not to input the captured image. In one embodiment, after clicking the image button to capture an image, the user may choose to browse and select an image from images stored in the mobile terminal for input, instead of shooting an image.

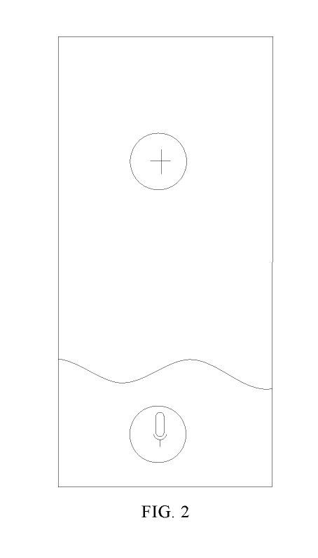

FIG. 2 illustrates a first application scenario of an input mode switching method in accordance with some embodiments of the present disclosure. As shown in FIG. 2, the first-type application program may be a personal assistant application program, and input interfaces of the audio input mode and the image input mode may be displayed simultaneously on a display interface of the mobile terminal. The audio input mode and the image input mode may be both in an activated state, and the user may be notified that both the image input mode and the audio input mode are available to use.

Each of the input interface of the audio input mode and the input interface of the image input mode may occupy a part of the region of the display interface. For example, as shown in FIG. 2, the input interface of the audio input mode occupies approximately ¼ of the display interface, and the input interface of the image input mode occupies approximately ¾ of the display interface. The ratio of the input interface of the audio input mode occupying the display interface to the input interface of the image input mode occupying the display interface may be configured based on practical need. Further, content other than the input interface of the audio input mode and the input interface of the image input mode may be displayed on the display interface. That is, the display interface of the mobile terminal may include other regions than the input interfaces of the audio input mode and the image input mode.

Further, after the application program is determined to be the first-type application program and the audio input mode and the image input mode are displayed on the display interface, at S103, detecting whether user-input information satisfies a first pre-configured condition for starting a first input mode, and if the user-input information satisfies the first pre-configured condition for starting the first input mode, starting the first input mode, may include: detecting, within a preset period of time, whether the user-input information is audio information; if the user-input information is not audio information, configuring the state of the audio input mode to be “deactivated” and configuring the state of the image input mode to be “activated”; and if the user-input information is audio information, configuring the state of the audio input mode to be “activated” and configuring the state of the image input mode to be “deactivated.” Under such situation, the first pre-configured condition is audio information being detected within a preset period of time, and correspondingly, the first input mode refers to the audio input mode.

In the “deactivated” state of an input mode, no information from the user can be input using such input mode. For example, the “deactivated” state of the audio input mode may refer to a state in which the audio receiver is deactivated to receive no audio data and the voice button is deactivated to generate no response to a click from the user. That is, when the audio input mode is in the “deactivated” state, no audio data can be recorded.

In the “activated” state of an input mode, the input mode is able to input information from the user. For example, the “activated” state of the audio input mode may refer to a state in which the audio receiver is activated to receive audio data, and the voice button can be clicked on to manually record audio data from the user. That is, when the audio input mode is in the “activated” state, audio data can be recorded, either automatically or manually.

Further, the aforementioned preset period of time may be configured based on practical situation. Assume the preset period of time is 3 seconds (approximately the interval between two audio responses), and the input interfaces of the audio input mode and the image input mode displayed on the display interface do not detect any user-input audio information within 3 seconds, the state of the audio input mode is then set to be “deactivated” and the state of the image input mode is set to be “activated”. For example, whether the input interfaces of the audio input mode and the image input mode has detected user-input audio information may be determined by whether there is a change in the design of the voice button or whether there is a visual effect associated with the detection of audio information on the input interfaces.

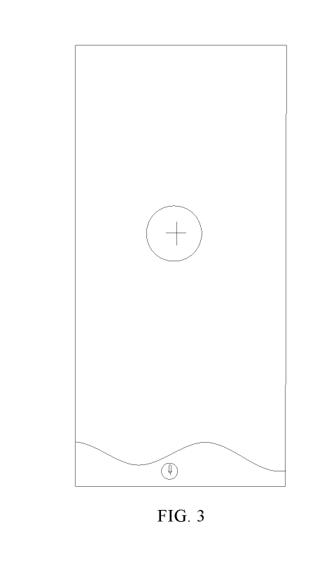

FIG. 3 illustrates a second application scenario of an input mode switching method in accordance with some embodiments of the present disclosure. As shown in FIG. 3, the input interface of the image input mode occupies almost the entire display interface of the mobile terminal. That is, when no audio information input by the user is detected by the input interfaces of the audio input mode and image input mode within a preset period of time (e.g., approximately 3 seconds), the state of the audio input mode may be set as “deactivated,” and the state of the image input mode may be set as “activated.”

In some embodiments, in response to the state of the audio input mode switching from “activated” to “deactivated,” the area of the input interface of the audio input mode may decrease gradually until the input interface of the audio input mode occupies only a preset ratio of the display interface of the mobile terminal, namely, the state of the audio input mode becomes “deactivated.” During this process, the input interface of the image input mode may increase gradually.

For example, referring to FIG. 2 and FIG. 3, the input interface of the audio input mode may decrease from approximately ¼ of the display interface (FIG. 2) to approximately 1/10 of the display interface (FIG. 3), and the input interface of the image input mode may increase from approximately ¾ of the display interface (FIG. 2) to approximately 9/10 of the display interface (FIG. 3). Further, in one embodiment, the voice button within the input interface of the audio input mode may become smaller as the input interface of the audio input mode decreases, while the image button representing the image input mode remains the same.

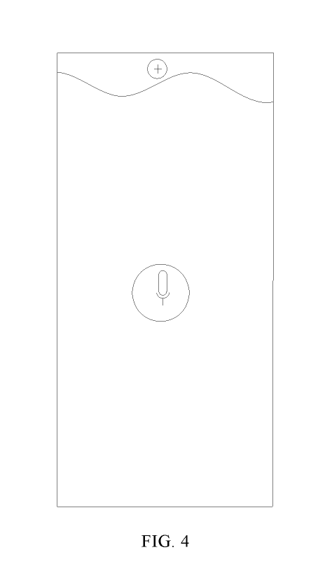

Further, under the situation in which the preset period of time is approximately 3 seconds, if the user-input audio information is detected within approximately 3 seconds by the input interface of the audio input mode and the image input mode displayed on the display interface, the state of the audio input mode is set to be “activated” and the state of the image input mode is set to be “deactivated.” FIG. 4 illustrates a third application scenario of an input mode switching method in accordance with the present disclosure. As shown in FIG. 4, the input interface of the audio input mode may occupy almost the entire display interface of the mobile terminal.

That is, in response to the state of the image input mode switching from “activated” to “deactivated,” the area of the input interface of the image input mode may decrease gradually until the input interface of the image input mode occupies only a preset ratio of the display interface, i.e., the state of the image input mode becomes “deactivated.” Correspondingly, the input interface of the audio input mode may increase gradually.

For example, referring to FIG. 2 and FIG. 3, the input interface of the image input mode may decrease from approximately ¾ of the display interface (FIG. 2) to approximately 1/10 of the display interface (FIG. 4), and the input interface of the audio input mode may increase from approximately ¼ of the display interface (FIG. 2) to approximately 9/10 of the display interface (FIG. 4). Further, in one embodiment, the image button within the input interface of the image input mode may become smaller as the input interface of the image input mode decreases, while the voice button representing the audio input mode remains the same.

In the aforementioned second and third application scenarios, the increase of the input interface may facilitate the user to use a desired input mode. Further, in some embodiments, as shown in FIG. 2, the input interface of the audio input mode is displayed at a lower region of the display interface, and the input interface of the image input mode is displayed at an upper region of the display interface. To help the user to use a corresponding input mode, the input interface of the audio input mode may still be displayed at the lower region of the display interface if decreased, and the input interface of the image input mode may still be displayed at the upper region of the display interface if decreased.

In some other embodiments, the positions of the input interfaces of the image input mode and the audio input mode may be exchanged based on actual situations. For example, the input interface of the image input mode may be displayed at a lower region of the display interface, and the input interface of the audio input mode may be displayed at an upper region of the display interface. As another example, when the state of the image input mode is “deactivated,” the input interface of the image input mode may be displayed at the lower region of the display interface.

In some embodiments, detecting whether user-input information satisfies a pre-configured condition for starting a second input mode, and if the user-input information satisfies the pre-configured condition for starting the second input mode, switching the first input mode to the second input mode (S104), may include when the state of the audio input mode is “deactivated,” if the user wants to use the audio input mode again, the user may push the input interface of the audio input mode upwards or long press an image in the input interface of the image input mode. Correspondingly, the ratio of the input interface of the audio input mode occupying the display interface of the mobile terminal may increase and the state of the audio input mode may become “activated.”

For example, the audio input mode may become “activated” when the ratio of the input interface of the audio input mode occupying the display interface is increased to 9/10. Further, a notification that the audio input mode is ready to use may pop up in the lower region of the display interface. Similarly, when the state of the image input mode is “deactivated” and the user wants to use the image input mode again, the image input mode may be started using an approach same as or similar to that described above and designed for starting the audio input mode.

In one embodiment, the process at S104 may further include: detecting whether the audio information currently input by the user includes a first preset keyword; and if the audio information includes the first preset keyword, configuring the state of the image input mode to be “activated.”

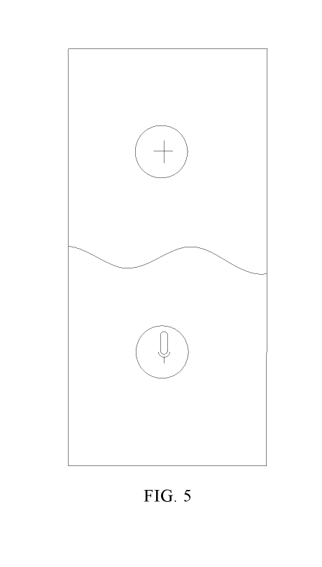

For example, the first preset keyword of the audio information may be a keyword associated with an object, such as “him, her, it.” When the audio information input by the user is detected to include the first preset keyword, the image input mode is started. Under such situation, the ratio of the input interface of the image input mode occupying the display interface may be increased automatically, to be equal to a value of ½. For example, FIG. 5 illustrates a fourth application scenario of an input mode switching method in accordance with some embodiments of the present disclosure. As shown in FIG. 5, the ratios of the input interfaces of the image input mode and the audio input mode occupying the display interface are both about ½.

The aforementioned descriptions of the disclosed input mode switching method may also be applied to application programs configured with audio input mode and text input mode, or application programs configured with text input mode and image input mode, or application program configured with three input modes, e.g., audio/image/text input modes. Corresponding conditions may thus be configured based on actual situations.

As such, based on information input by the user and information not input by the user, the technical solutions of the present disclosure may start a first input mode of the application program, and switch the first input mode to a second input mode when a pre-configured condition for starting the second input mode is satisfied. Accordingly, the issue affecting the operation fluency encountered by the user when manually switching the input modes may be avoided.

In another embodiment, configuring a corresponding input mode for the application program based on a type of the application program (S102), may include: determining whether the application program is a second-type application program; if the application program is the second-type application program, configuring text input mode, audio input mode, and image input mode for the second-type application program. The second-type application program may be, for example, a chat application program.

Further, input interface(s) of one or more default input modes may be displayed on the display interface of the mobile terminal. The one or more default input modes may include at least one of the text input mode, the audio input mode, or the image input mode. When input is performed on the input interface of a displayed input mode, the corresponding input mode may be started.

Further, when the text input mode or the audio input mode is started, whether the text information or the audio information input by the user includes a second preset keyword is detected. The second preset keyword may be, for example, a keyword associated with image. If the text information or audio information includes the second preset keyword, the input mode may be switched from the text input mode or the audio input mode to the image input mode. For example, when the user uses text or audio to chat with another person through a chatting page, the user may mention the second preset keyword such as “photo,” “look,” “image,” “sent,” or “selfie.” In response to such second preset keyword mentioned by the user, the input interface of the image input mode may be automatically popped up on the display interface. Thus, the user may conveniently and rapidly switch to use the image input mode for input.

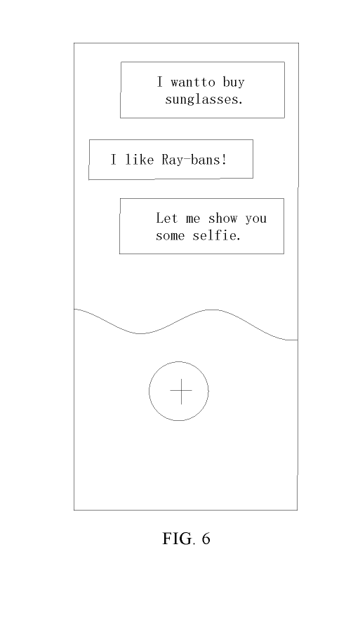

For example, FIG. 6 illustrates an application scenario in which an input interface of an image input mode is popped up to start the image input mode when a text input mode is started. As shown in FIG. 6, the user may chat with a friend using the text input mode. The user may initiate a chat by inputting “I want to buy sunglasses,” and the user's friend may respond by saying “I like Ray-bans!” The user may continue the topic by typing “Let me show you some selfie.” Since “selfie” is a second preset keyword, an input interface of the image input mode may be popped up and be displayed at the lower region of the display interface of the mobile terminal. Thus, the user may conveniently send his or her friend a selfie using the popped-up input interface of the image input mode.

In one embodiment, when the current input mode is text input mode, i.e., the text input mode is started, whether the currently input text information includes a third preset keyword is detected. If the currently input text information include the third preset keyword, the text input mode may be switched to audio input mode. For example, when the user uses text to chat with another person through the chatting page and mentions a third preset keyword such as “sing” or “listen,” the input mode may be switched from the text input mode to the audio input mode automatically, thereby saving the user from clicking operations.

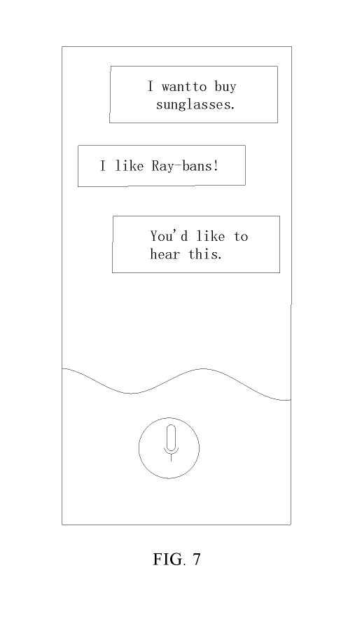

For example, FIG. 7 illustrates a schematic view showing switching from the text input mode to the audio input mode. As shown in FIG. 7, the user may chat with a friend using the text input mode. The user may initiate a chat by inputting text information “I want to buy sunglasses,” and the user's friend may respond by saying “I like Ray-bans!” The user may continue the topic by typing “You'd like to hear this.” Since “hear” is a third preset keyword, an input interface of the audio input mode may be popped up and be displayed at the lower region of the display interface of the mobile terminal. Thus, the user may conveniently send his or her friend an audio message using the popped-up input interface of the audio input mode.

In one embodiment, when the current input mode is audio input mode, i.e., the audio input mode is started, whether the currently input audio information includes a fourth preset keyword or a preset short text is detected. The fourth preset keyword or the preset short text may, for example, indicate that the user prefers to use text input mode. If the currently input audio information includes the fourth preset keyword (e.g., meeting), the audio input mode is switched to the text input mode. For example, when the user uses audio to chat with another person through a chatting page and mentions the fourth preset keyword or the preset short text such as “will have a meeting” or “talk to you later,” the input mode may be switched from the audio input mode to the text input mode automatically, thereby reducing the operation of clicking.

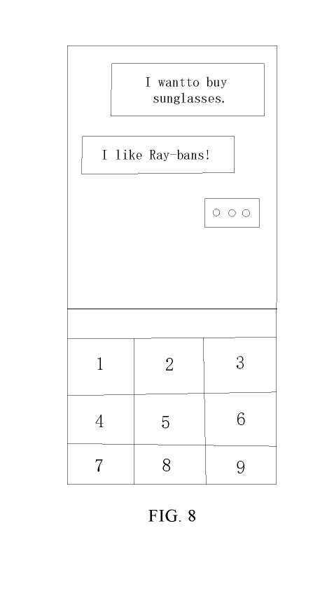

For example, FIG. 8 illustrates a schematic view showing switching from the audio input mode to the text input mode. As shown in FIG. 8, the user may initially chat with a friend using the text input mode. The user may initiate a chat by inputting text information “I want to buy sunglasses,” and the user's friend may respond by saying “I like Ray-bans!” The user may then be notified to attend a meeting and under the audio input mode, says “I need to attend a meeting.” Optionally, the specific content of the audio message may not be displayed as text on the chatting page, and the specific content may be shown as “ . . . ” on the chatting page.

Further, in response to the audio message including the preset short text “attend a meeting,” an input interface of the text input mode may be popped up and be displayed at the lower region of the display interface of the mobile terminal, thus allowing the user to conveniently continue sending his or her friend text messages using the popped-up input interface of the text input mode.

Based on the information input by the user, the technical solutions of the present disclosure may select to start the first input mode, and when the pre-configured condition of the second input mode is satisfied, the current first input mode may be switched to the second input mode. Accordingly, the issue of the user feeling interrupted when manually switching the input modes may be prevented.

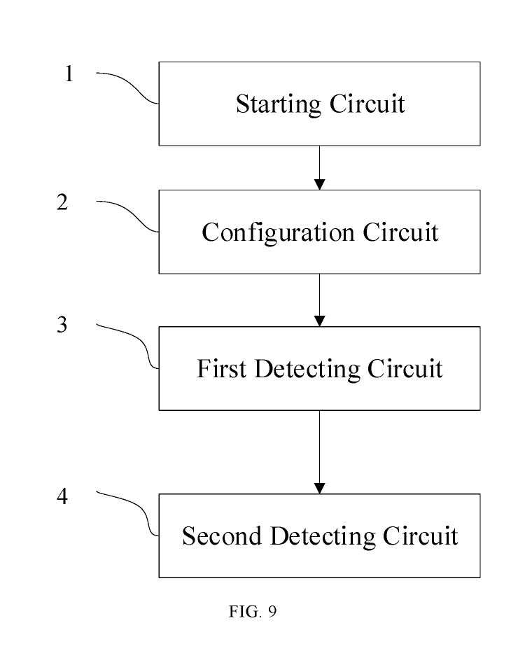

FIG. 9 illustrates a schematic view of an input mode switching device in accordance with some embodiments of the present disclosure. As shown in FIG. 9, the disclosed input mode switching device includes a starting circuit 1, a configuration circuit 2, a first detecting circuit 3, and a second detecting circuit 4. The starting circuit 1 may be configured to start an application program, and the configuration circuit 2 may configure one or more corresponding input modes for the application program based on a type of the application program. The first detecting circuit 3 may detect whether user-input information satisfies a pre-configured condition for starting a first input mode. If the user-input information satisfies the pre-configured condition for starting the first input mode, the first detecting circuit 3 starts the first input mode.

The second detecting circuit 4 is configured to detect whether user-input information satisfies a pre-configured condition for starting a second input mode. If the user-input information satisfies the pre-configured condition for starting the second input mode, the second detecting circuit 4 may switch the input mode from the first input mode to the second input mode.

For the disclosed input mode switching device, mechanism of applying the aforementioned device to realize switching between input modes may be the same as the mechanism of applying the input mode switching method disclosed with reference to FIGS. 1-8. Thus, for detailed descriptions of the input mode switching device, reference can be made to descriptions related to FIGS. 1-8, which are not repeated here.

As such, based on the information input by the user, the disclosed embodiments may start the first input mode of an application program, and when the pre-configured condition for starting the second input mode is satisfied, the first input mode may be switched to the second input mode. Accordingly, the issue of the user feeling interrupted when manually switching the input modes may be prevented.

Based on embodiments of the present disclosure, the aforementioned method, device, unit and/or module may be implemented by using an electronic device having the computing capacity to execute software that comprises computer instructions. Such system may include a storage device for implementing various storage manners mentioned in the foregoing descriptions. The electronic device having the computing capability may include a device capable of executing computer instructions, such as a general-purpose processor, a digital signal processor, a specialized processor, a reconfigurable processor, etc., and the present disclosure is not limited thereto. Execution of such instructions may allow the electronic device to be configured to execute the aforementioned operations of the present disclosure. The above-described device and/or module may be realized in one electronic device, or may be implemented in different electronic devices. Such software may be stored in a computer readable storage medium. The computer storage medium may store one or more programs (software modules), the one or more programs may comprise instructions, and when the one or more processors in the electronic device execute the instructions, the instructions enable the electronic device to execute the disclosed method.

Such software may be stored in forms of volatile memory or non-volatile memory (e.g., storage device similar as ROM), no matter whether it is erasable or overridable, or may be stored in the form of memory (e.g., RAM, memory chip, device or integrated circuit), or may be stored in optical readable media or magnetic readable media (e.g., CD, DVD, magnetic disc, or magnetic tape, etc.). It should be noted that, the storage device and storage media are applicable to machine-readable storage device embodiments storing one or more programs, and the one or more programs comprise instructions. When such instructions are executed, embodiments of the present disclosure are realized. Further, the disclosed embodiments provide programs and machine-readable storage devices storing the programs, and the programs include codes configured to realize the device or method described in any of the disclosed claims. Further, such programs may be electrically delivered via any medium (e.g., communication signal carried by wired connection or wireless connection), and various embodiments may appropriately include such programs.

The method, device, unit and/or module according to the embodiments of the present disclosure may further use a field-programmable gate array (FPGA), programmable logic array (PLA), system on chip (SOC), system on the substrate, system on encapsulation, application-specific integrated circuit (ASIC), or may be implemented using hardware or firmware configured to integrate or encapsulate the circuit in any other appropriate manner, or may be implemented in an appropriate combination of the three implementation manners of software, hardware, and firmware. Such system may include a storage device to realize the aforementioned storage. When implemented in such manners, the applied software, hardware, and/or firmware may be programmed or designed to execute the corresponding method, step, and/or function according to the present disclosure. Those skilled in the relevant art may implement one or more, or a part or multiple parts of the systems and modules by using different implementation manners appropriately based on actual demands. Such implementation manners shall all fall within the protection scope of the present disclosure.

Though the present disclosure is illustrated and described with reference to specific exemplary embodiment of the present disclosure, those skilled in the relevant art should understand that, without departing from appended claims and the spirit and scope of the present disclosure defined equivalently, various changes may be made to the present disclosure in the manner and detail. Therefore, the scope of the invention shall not be limited to the aforementioned embodiments, but shall be determined by the appended claims, and may be further defined by equivalents of the appended claims.

What is claimed is:

1. An input mode method comprising:
providing a first input mode of an application program which receives a first type of information from a user;
detecting whether the first type of information comprises a pre-configured condition for switching the first input mode of the application program to a second input mode of the application program, wherein the second input mode of the application program receives a second type of information from the user; and
if so, switching the first input mode of the application program to the second input mode of the application program.

2. The method according to claim 1, wherein:
providing the first input mode includes providing an audio input mode for the application program and displaying an input interface of the audio input mode on a display interface of a mobile terminal; and
switching to the second input mode includes switching to an image input mode for the application program and displaying an input interface of the image input mode on the display interface.

3. The method according to claim 2, wherein detecting whether the first type of information comprises a pre-configured condition includes:
detecting, within a preset period of time, whether the first type of input information is not audio information.

4. The method according to claim 2, wherein:
the first type of information includes audio information; and
detecting whether the first type of information comprises the pre-configured condition includes detecting whether the audio information includes a preset keyword.

5. The method according to claim 1, wherein:
providing the first input mode includes providing one of a text input mode, an audio input mode, and an image input mode for the application program; and
switching to the second input mode includes switching to another one of the text input mode, the audio input mode, and the image input mode.

6. The method according to claim 5, wherein:
providing the first input mode further includes displaying an input interface of the one of the text input mode, the audio input mode, and the image input mode on a display interface of a mobile terminal; and
switching to the second input mode further includes displaying an input interface of the other one of the text input mode, the audio input mode, and the image input mode.

7. The method according to claim 5, wherein:
the first input mode is the text input mode and the first type of information includes text information;
the second input mode is the image input mode; and
detecting whether the first type of information comprises the pre-configured condition includes detecting whether the text information includes a preset keyword.

8. The method according to claim 5, wherein:
the first input mode is the text input mode and the first type of information includes text information;
the second input mode is the audio input mode; and
detecting whether the first type of information comprises the pre-configured condition includes detecting whether the text information includes a preset keyword.

9. The method according to claim 5, wherein:
the first input mode is the audio input mode and the first type of information includes audio information;
the second input mode is the text input mode; and
detecting whether the first type of information comprises the pre-configured condition includes detecting whether the audio information includes a preset keyword.

10. A device, comprising:
a processor; and
an input device coupled to the processor, the input device being configured to receive a first type of information from a user via a first input mode,
wherein the processor is configured to
detect whether the first type of information from the user and as received by the input device comprises a pre-configured condition for switching the first input mode of the input device to a second input mode of the input device, the second input mode of the input device being configured to receive a second type of information from the user; and
responsive to the detected first type of information from the user comprising the pre-configured condition, switch the first input mode of input device to the second input mode in order to receive the second type of information from the user.

11. The device according to claim 10, further comprising:
a display interface;
wherein the processor is further configured to:
provide an audio input mode for an application program as the first input mode and displaying an input interface of the audio input mode on the display interface; and
switch to an image input mode for the application program as the second input mode and display an input interface of the image input mode on the display interface.

12. The device according to claim 11, wherein the pre-configured condition includes that the first type of information is not audio information.

13. The device according to claim 11, wherein:
the first type of information includes audio information; and
the pre-configured condition includes that the audio information includes a preset keyword.

14. The device according to claim 10, wherein:
the first input mode includes one of a text input mode, an audio input mode, and an image input mode for an application program; and
the second input mode includes another one of the text input mode, the audio input mode, and the image input mode.

15. The device according to claim 14, further comprising:
a display interface;
wherein the processor is further configured to:
display an input interface of one of the text input mode, the audio input mode, and the image input mode on the display interface; and
in response to switching to the second input mode, display an input interface of the other one of the text input mode, the audio input mode, and the image input mode.

16. The device according to claim 14, wherein:
the first input mode is the text input mode and the first type of information includes text information;
the second input mode is the image input mode; and
the pre-configured condition includes that the text information includes a preset keyword.

17. The device according to claim 14, wherein:
the first input mode is the text input mode and the first type of information includes text information;
the second input mode is the audio input mode; and
the pre-configured condition includes that the text information includes a preset keyword.

18. The device according to claim 14, wherein:
the first input mode is the audio input mode and the first type of information includes audio information;
the second input mode is the text input mode; and
the pre-configured condition includes that the audio information includes a preset keyword.
